(19) United States
(12) Patent Application Publication
(10) Pub. No.: US 2024/0227104 A1
(43) Pub. Date: Jul. 11, 2024

(54) MACHINE TOOL

(71) Applicant: FUJI CORPORATION, Chiryu (JP)

(72) Inventor: Kazuya ASAKAWA, Toyota-shi (JP)

(73) Assignee: FUJI CORPORATION, Chiryu (JP)

(21) Appl. No.: 18/558,564

(22) PCT Filed: May 26, 2021
(86) PCT No.: PCT/JP2021/020030

§ 371 Date: Nov. 2, 2023

(51) Int. Cl. B23Q 11/00; B23Q 11/10

(52) U.S. Cl. CPC B23Q 11/0057; B23Q 11/0064; B23Q 11/1069

(57) ABSTRACT

A machine tool including a machining device configured to perform machining on a workpiece in a machining chamber, a chip conveyor including a reservoir tank into which machining chips generated by workpiece machining in the machining device flow, together with a coolant, the chip conveyor being configured to discharge the machining chips to an outside of the machine tool, a coolant tank in which the chip conveyor is incorporated, the coolant tank being configured to accumulate the coolant flowing out of the reservoir tank, a sub-tank provided to surround an outer side of a discharge window for the coolant, the discharge window being formed on a side surface of the reservoir tank, and a machining chip removal section in which a magnetic separator made of a magnet is accommodated in the sub-tank and an opening portion configured to filter the coolant is provided around the magnetic separator.

### TECHNICAL FIELD

The present disclosure relates to a machine tool for collecting chips, scraps, and the like by including a sub-tank in a coolant tank.

### BACKGROUND ART

In a machine tool, chips and scraps generated from a cutting-machined workpiece are washed away by a coolant, and large scraps and the like are accumulated in a reservoir tank below the machine body and then discharged to the outside of the machine body by a conveyor. Further, the coolant in which fine chips and the like remain is filtered through a filter, and is sent again from the coolant tank to the machining section or the cleaning area using a pump. In order to repeatedly use the coolant in the machine tool, it is necessary to appropriately remove chips and the like mixed in the coolant, and various removal structures for chips and the like have been proposed.

The machine tool described in the following Patent Literature 1 includes a tank of the machine tool for storing a coolant including an untreated tank for storing an untreated coolant mixed with foreign substances such as chips, and a treated tank for storing the coolant from which the chips and the like are removed, and in the communication path between the untreated tank and the treated tank, a magnetic separator, in which multiple attraction rods with vinyl tubes attached to a magnet are supported by a frame made of non-magnetic material such as aluminum, is provided together with a net filter. Therefore, when the untreated coolant flows into the treated tank, large scraps are removed by the net filter, and fine chips are further removed by the magnetic separator.

In addition, the machine tool described in the following Patent Literature 2 is provided with a filtering device of the machine tool that is divided into a waste liquid tank and a filtered liquid tank in which a filtered coolant is accumulated, and large chips are precipitated at the bottom of the waste liquid tank. A plate-shaped magnet is disposed on the bottom surface of the waste liquid tank, the precipitated chips are prevented from floating in the waste liquid again, and are attracted to the plate-shaped magnet and scraped out to the outside by a chip transfer plate attached to a chain conveyor. Further, an attracting disk device is provided, and thus the chips attracted on the attraction surface are carried by rotating the magnet plate inside the attraction case, and when the distance from the magnet plate increases, the chips are dropped and collected.

### PATENT LITERATURE

Patent Literature 1: JP-A-H10-100039
Patent Literature 2: JP-A-2015-112669

### BRIEF SUMMARY

### Technical Problem

As described in Patent Literatures 1 and 2, there are various removal structures for machine tools to reuse the coolant from which chips, scraps, and the like are removed. However, the removal structure for chips, scraps, and the like in the conventional art occupies a large space in the coolant tank, and this becomes a factor that inhibits reducing the size of the machine tool. In particular, in the removal structure of the second Patent Literature, an attracting disk device or the like is a large device that protrudes largely upward from the coolant tank, and the structure thereof is also complicated. In addition, for example, in the removal structure of Patent Literature 1, chips and the like attracted to the attraction rods have to be scraped off, and not only the work is troublesome, but also the work load is large as long as the magnetic separator is heavy, and thus it is considered that fine chips and the like are difficult to easily drop off.

An object of the present disclosure is to provide a machine tool that removes chips and scraps from a coolant in a sub-tank.

### Solution to Problem

A machine tool according to an aspect of the present disclosure includes: a machining device configured to perform machining on a workpiece in a machining chamber; a chip conveyor including a reservoir tank into which machining chips generated by workpiece machining in the machining device flow, together with a coolant, the chip conveyor being configured to discharge the machining chips to an outside of the machine tool; a coolant tank in which the chip conveyor is incorporated, the coolant tank being configured to accumulate the coolant flowing out of the reservoir tank; a sub-tank provided to surround an outer side of a discharge window for the coolant, the discharge window being formed on a side surface of the reservoir tank; and a machining chip removal section in which a magnetic separator made of a magnet is accommodated in the sub-tank and an opening portion configured to filter the coolant is provided around the magnetic separator.

### Advantageous Effects

With the above configuration, the machining chips, which are generated by workpiece machining in the machining device, flow from the reservoir tank of the chip conveyor in which the machining chips flowed in together with the coolant through the discharge window and into the sub-tank, together with the machining chips. The machining chips are attracted by the magnetic separator placed in the separate case, and the coolant, from which the machining chips are removed by the filtering plate, flows out through the opening portion.

### BRIEF DESCRIPTION OF DRAWINGS

FIG. 1 is a perspective view of an internal structure showing an embodiment of a machine tool.

FIG. 2 is a perspective view showing a main configuration of a coolant system.

FIG. 3 is a perspective view showing a machining chip removal section in a sub-tank.

FIG. 4 is a perspective view of the machining chip removal section showing a cleaning status of a magnetic separator.

FIG. 5 is a perspective view showing a removal status of the magnetic separator.

FIG. 6 is a view showing a usage status of a scraping rod in the sub-tank.

### DESCRIPTION OF EMBODIMENTS

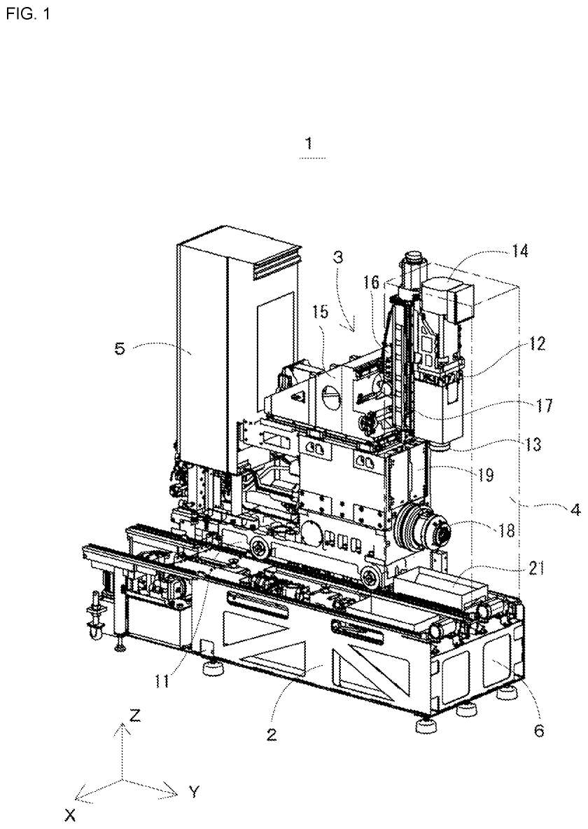

An embodiment of a machine tool according to the present disclosure will be described below with reference to the drawings. In the present embodiment, a machining center will be described as an example of the machine tool. FIG. 1 is a perspective view of an internal structure of the machining center. Machining center 1 is entirely covered with a machine body cover (not shown), and is configured with machining chamber 4, indicated by a one-dot chain line, in which workpiece machining is performed. Machining center 1 is assembled on movable bed 11, and has a structure that is movable in a front-rear direction over base 2.

Machining center 1 constitutes a machining equipment line in which multiple work machines such as other machine tools and inspection devices are arranged in a width direction. The machining equipment line is configured to be compact to suppress a width dimension, and two modularized various work machines are mounted on one base 2. Accordingly, in the machining equipment line, the required number of bases 2 are arranged in the width direction (X-axis direction), and multiple work machines are arranged close to each other. The work machines are all assembled on movable bed 11, move along rails 201 in the front-rear direction (Y-axis direction), and can perform tool exchange, maintenance, and the like in a pulled-out state.

Machining center 1 is provided with spindle head 12 for holding a tool at a front part thereof, includes spindle chuck 13 capable of attaching and detaching tools such as drills, and is configured such that the attached tool is rotated by spindle motor 14. Spindle head 12 is mounted on machining drive device 3 to be movable in three axial directions where operations such as machining, component exchange, and the like are involved. In machining drive device 3, X-axis slide 16 that moves in a machine body width direction with respect to Y-axis slide 15 that moves in a machine body front-rear direction is mounted, and Z-axis slide 17 that moves in a machine body up-down direction with respect to X-axis slide 16 is mounted. The movement of each slide is configured to convert the rotation output of the servo motor into linear motion through a ball screw mechanism.

Below spindle head 12 moved by machining drive device 3, chuck device 18 that rotatably grips a workpiece and tool magazine 19 that is positioned behind chuck device 18 are incorporated. Tool magazine 19 accommodates multiple tools between chuck device 18 and spindle head 12, and an automatic tool exchanger is incorporated inside the opening and closing door. Control device 5 for controlling the drives of components such as spindle head 12, chuck device 18, machining drive device 3, and also tool magazine 19 is mounted on machining center 1.

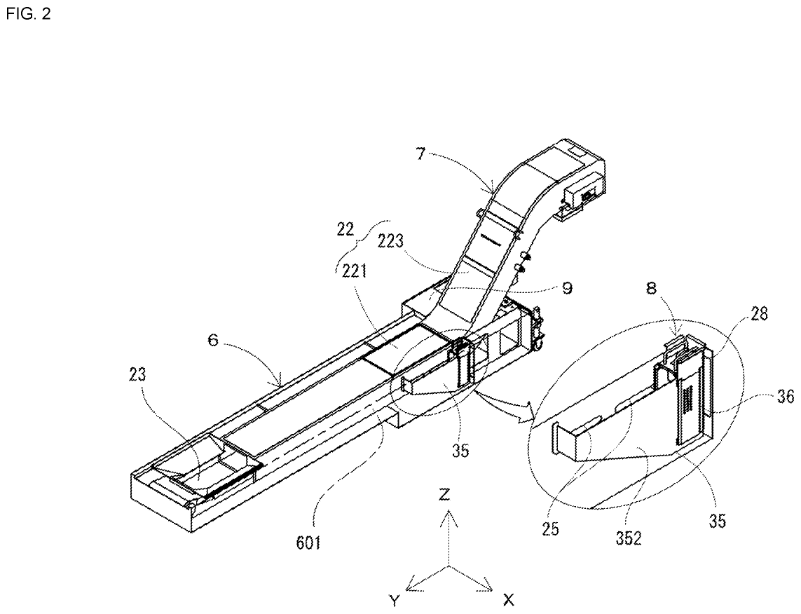

Machining center 1 uses a coolant, during workpiece machining, not only for lubrication but also for washing away chips, scraps, and the like (hereinafter collectively referred to as “machining chips”). Therefore, coolant tank 6 for accumulating the used coolant is provided in base 2. Specifically, as shown in FIG. 2, chip conveyor 7 that separates the machining chips from the coolant and transports the machining chips outside of the machine is incorporated in base 2 in such a way that chip conveyor 7 is accommodated in coolant tank 6. Chip conveyor 7 is connected to machining chamber 4 through inlet 21, and it is configured such that the coolant flowed during workpiece machining is accumulated together with the machining chips.

FIG. 2 is a perspective view showing a main configuration of a coolant system. The coolant system includes, in addition to coolant tank 6 and chip conveyor 7, a pipe, a pump, and the like that send the coolant to machining chamber 4 and the like. In chip conveyor 7, a belt conveyor which is an endless belt for conveying machining chips is incorporated in conveyor main body 22 having reservoir tank 221 horizontally extending toward the rear side of the machine body in base 2 and elevating conveyor section 223 protruding from the rear side of base 2 and extending upward. In reservoir tank 221, drain outlet 23 overlapping with inlet 21 of machining chamber 4 is formed in the front end portion of reservoir tank 221, and the machining chips and the coolant flow down from machining chamber 4 through drain outlet 23 are accumulated.

Chip conveyor 7 conveys the machining chips accumulated in reservoir tank 221 to the rear of the machine body through the drive of the belt conveyor, and then the machining chips are moved up on elevating conveyor section 223. The belt conveyor is folded back at a top portion of elevating conveyor section 223, and the machining chips conveyed to the top portion are dropped from the discharge port and collected in a collection box installed below. Meanwhile, the coolant remaining in reservoir tank 221 flows into coolant tank 6 on the outer side, and is supplied to machining chamber 4 side again after fine machining chips are removed.

Discharge windows 25 are formed in reservoir tank 221 at positions lower than the liquid level, and the coolant in reservoir tank 221 is accumulated in coolant tank 6 through discharge windows 25. Further, in order to prevent overflow in reservoir tank 221, it is configured to actively discharge the coolant using a pump provided on the secondary side.

The coolant passing through discharge windows 25 is a dirty liquid containing a large amount of machining chips, which may cause the pump to break down when the dirty liquid is untreated. Therefore, up until now, discharge windows 25 have been blocked by filtering nets such as punched metal. However, when perforations in the punched metal are too fine, an overflow occurs due to clogging. Once an overflow occurs, the coolant system needs to be pulled out of base 2 to clean the precipitated machining chips, which takes time to recover the machine. Further, even when performing regular maintenance, the work is not easy. On the other hand, as long as the perforations in punched metal are coarse, the coolant containing a large amount of chips and the like flows into the pump, which causes the pump to break down.

In a machine tool such as machining center 1, generation amounts of fine chips and relatively large scraps are different depending on machining contents, and it is difficult to set the size of the perforations in the punched metal. Therefore, a management burden to prevent issues as described above from occurring was substantial. Here, in the present embodiment, a simple opening window is used, from which the punched metal is removed from discharge windows 25, and instead, sub-tank 35 including machining chip removal section 8 is provided on the outer side of conveyor main body 22. In coolant tank 6 shown in FIG. 2, side surface 601 indicated by a one-dot chain line on the front side of the drawing is omitted, but sub-tank 35 is joined to protrude from the side surface of reservoir tank 221, and is present in coolant tank 6.

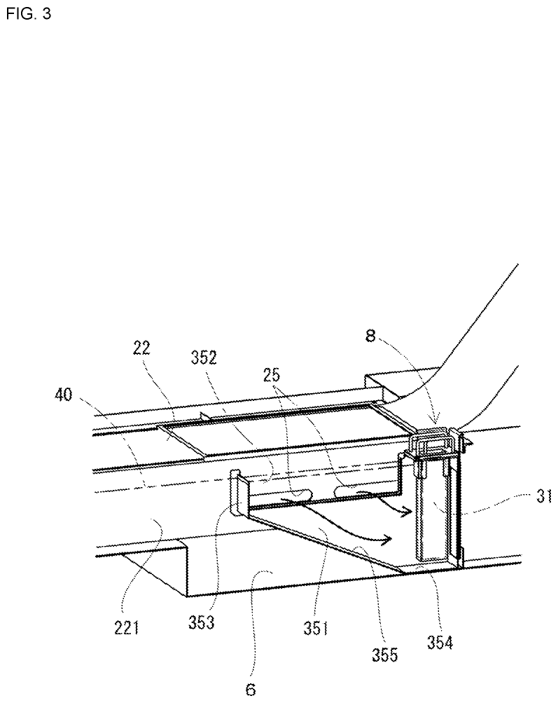

FIG. 3 is a perspective view showing machining chip removal section 8 in sub-tank 35, in which outer side surface 352 on the front side of the drawing is omitted. Inner side surface 351 of sub-tank 35 is joined to the side surface of reservoir tank 221 and has a depth reaching the bottom surface of coolant tank 6. Sub-tank 35 has a container shape with a narrow width of which an upper surface side is opened, and inner side surface 351 is deeply cut out so that discharge windows 25 are positioned in sub-tank 35. An upper opening end of sub-tank 35 is formed to be higher than liquid level 40 of the coolant indicated by a two-dot chain line, to prevent coolant containing the machining chips that flowed in from discharge windows 25 from flowing directly into coolant tank 6.

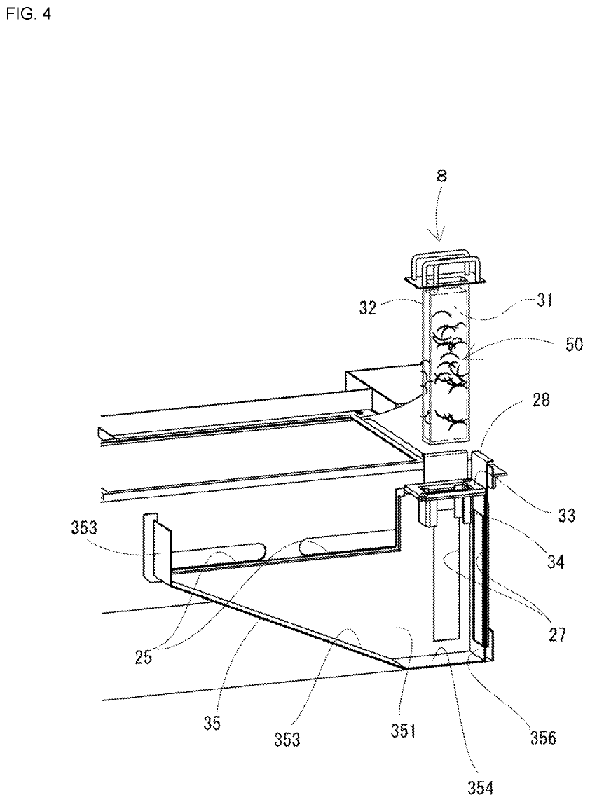

In sub-tank 35, inclined surface 355 is formed from front surface 353 to bottom surface 354 on the rear side so that the machining chips contained in the coolant that flowed in gather on the rear side, and magnetic separator 31 is provided in a rear portion thereof. FIG. 4 is a perspective view of machining chip removal section 8 showing a cleaning status of magnetic separator 31. Opening portion 27 is formed in inner side surface 351, outer side surface 352, and rear surface 356 which are three wall surfaces in a rear portion of sub-tank 35. Slit 36 (refer to FIG. 2) is formed on the outer sides of inner side surface 351, outer side surface 352, and rear surface 356, and filtering plate 28 equipped with fine punched metal as a filtering net can be inserted and removed in the up-down direction.

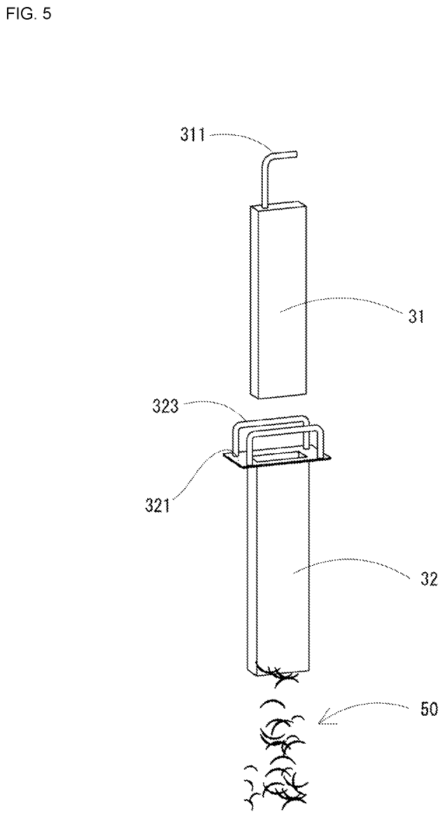

Accordingly, the punched metal of filtering plate 28 overlaps with opening portion 27, and the coolant from which the machining chips are removed is sent to coolant tank 6. Machining chip removal section 8 is provided such that magnetic separator 31 is surrounded by opening portions 27 from three sides. FIG. 5 is a perspective view showing a removal status of magnetic separator 31. Magnetic separator 31 is a thin cube-shaped magnet having handle 311 attached to an upper portion thereof, and is inserted into separate case 32 and placed in sub-tank 35.

Separate case 32 is a non-magnetic container made of stainless steel or the like having the same size that allows the insertion and removal of magnetic separator 31, and at the opened upper end of separate case 32, flange 321 is formed and handle 323 is attached. Rectangular ring-shaped support plate 33 is fixed to an upper opening end of sub-tank 35, and separate case 32 is inserted into support plate 33 in such a way that flange 321 is hooked thereon. Under support plate 33, guide plates 34 are joined to face each other. Thus, magnetic separator 31 inserted into separate case 32 is removably installed in the rear portion formed deep in sub-tank 35.

Next, the operation of machining center 1 will be described. First, the workpiece gripped by chuck device 18 is subjected to cutting, drilling, or the like by the tool attached to spindle chuck 13, and the machining chips washed away by the coolant are accumulated in reservoir tank 221 of chip conveyor 6. Then, the coolant in reservoir tank 221 flows into sub-tank 35 through discharge windows 25 while containing the machining chips.

The coolant in sub-tank 35 flows into machining chip removal section 8, passes through the punched metal from opening portions 27 provided in the three surfaces, and flows into coolant tank 6. In this case, since the coolant flows near magnetic separator 31, a large amount of machining chips is attracted to magnetic separator 31 by the magnetic force before being caught by the punched metal. At this time, machining chips 50 are not directly attracted to magnetic separator 31, but adhere to the surface of separate case 32 around magnetic separator 31 (refer to FIG. 4).

The coolant, from which the machining chips are removed by magnetic separator 31 of machining chip removal section 8, as well as by the punched metal of filtering plate 28, flows out from sub-tank 35 to coolant tank 6 and is sucked into pump tank 9. Then, the coolant is sent to a cyclone filter (not shown) using a pump. In the cyclone filter, sludge is separated by the centrifugal force of the generated vortex, and the coolant in the form of a clean liquid is discharged. The coolant thus regenerated is passed through the pipe and used again for lubrication or for washing away machining chips during workpiece machining.

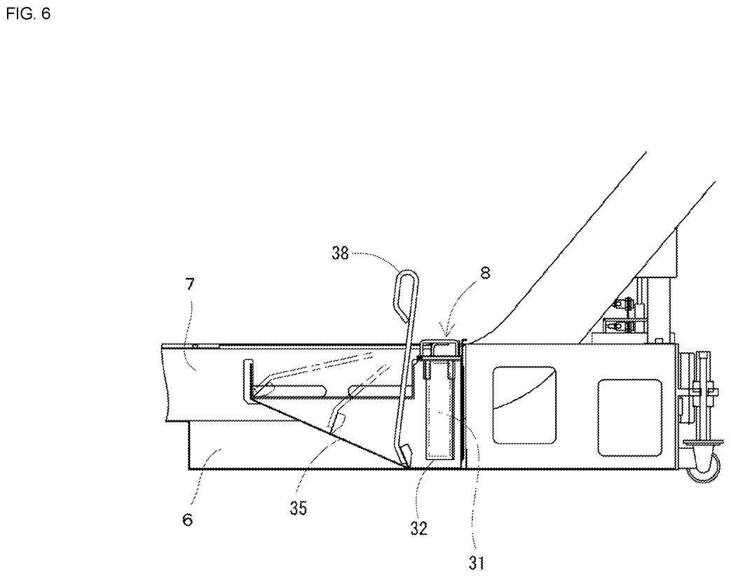

In machining chip removal section 8 of the present embodiment, since magnetic separator 31 attracts the machining chips, the coolant, from which the machining chips are removed, can be sent to pump tank 9 without clogging the punched metal of opening portions 27. In machining chip removal section 8, cleaning for collecting the machining chips is periodically performed. In sub-tank 35, the machining chips may remain on inclined surface 355. Therefore, scraping rod 38 shown in FIG. 6 is provided, and the operator scrapes the machining chips from the top of inclined surface 355 downward and causes the machining chips to be attracted to magnetic separator 31.

Thereafter, as shown in FIG. 4, magnetic separator 31 is pulled out from sub-tank 35 together with separate case 32, and as further shown in FIG. 5, magnetic separator 31 is pulled out from separate case 32. As a result, machining chips 50 taken out of sub-tank 35 are released from the magnetic force adhering to the surface of separate case 32, and fall into the provided collection box to be collected. Thereafter, magnetic separator 31 is inserted into separate case 32 again and attached to the inside of sub-tank 35. In addition, filtering plate 28 equipped with the punched metal is also removed from each side surface of sub-tank 35, and is returned again after the machining chips causing clogging are removed.

Thus, in the present embodiment, since machining chip removal section 8 is provided in sub-tank 35 and discharge windows 25 of reservoir tank 221 do not have filtering nets such as punched metal, it is possible to resolve the overflow issue described above. Further, machining chip removal section 8 can remove the machining chips from the coolant so as not to break down the pump by providing magnetic separator 31 and the punched metal of opening portions 27. Magnetic separator 31 can easily remove the machining chips by being pulled out from separate case 32 accommodated therein, and cleaning is extremely easy.

Sub-tank 35 is formed with inclined surface 355 to be deeper toward the rear side where the coolant flows, and is configured such that the machining chips gather on magnetic separator 31, so that the machining chips can be effectively collected. Further, the configuration of magnetic separator 31 stored in separate case 32 is simple and easy to handle. Further, modularized machining center 1 needs to minimize the machine width dimension. In response to this requirement, sub-tank 35 accommodating machining chip removal section 8 is configured to be compact.

Although one embodiment of the present disclosure has been described, the present disclosure is not limited to the embodiment, and various modifications can be made without departing from the gist thereof.

For example, a machining center has been described as an example of a machine tool in the above embodiment, but a lathe or the like may be used. Further, the present disclosure can compactly configure a sub-tank accommodating a machining chip removal section for a machine tool where there is a need to minimize the width dimension, but it is also effective for a large-sized machine in which such a requirement is not present. Furthermore, in machining chip removal section 8 of the above embodiment, the configuration is shown where magnetic separator 31 is stored in separate case 32, but the machining chips may be directly attracted to magnetic separator 31.

### REFERENCE SIGNS LIST

1: machining center, 2: base, 4: machining chamber, 6: coolant tank, 7: chip conveyor, 8: machining chip removal section, 22: conveyor main body, 25: discharge window, 31: magnetic separator, 32: separate case, 35: sub-tank, 221: reservoir tank

1. A machine tool comprising:
a machining device configured to perform machining on a workpiece in a machining chamber;
a chip conveyor including a reservoir tank into which machining chips generated by workpiece machining in the machining device flow, together with a coolant, the chip conveyor being configured to discharge the machining chips to an outside of the machine tool;
a coolant tank in which the chip conveyor is incorporated, the coolant tank being configured to accumulate the coolant flowing out of the reservoir tank;
a sub-tank provided to surround an outer side of a discharge window for the coolant, the discharge window being formed on a side surface of the reservoir tank; and
a machining chip removal section in which a magnetic separator made of a magnet is accommodated in the sub-tank and an opening portion configured to filter the coolant is provided around the magnetic separator.

2. The machine tool according to claim 1, wherein a bottom of the sub-tank is inclined from a position on a side where the discharge window is formed toward a position where the machining chip removal section is configured.

3. The machine tool according to claim 1, wherein the sub-tank is a container-shaped case with a narrow width of which an upper surface side is opened, and the machining chip removal section is a thin cube-shaped magnet in which the magnetic separator can be inserted into and removed from a separate case made of a non-magnetic material.

4. The machine tool according to claim 1, wherein, in the machining chip removal section, a rectangular ring-shaped support plate is fixed to an upper opening end of the sub-tank, so that the separate case is inserted into the support plate in such a way that a flange portion is hooked onto the support plate, and a handle is provided on the magnetic separator and the separate case.

5. The machine tool according to claim 1, wherein the machining chip removal section is configured such that a filtering plate configured to filter the coolant is disposed on an outer side of the opening portion and can be inserted and removed in an up-down direction.
